(19) United States
(12) Patent Application Publication
(10) Pub. No.: US 2026/0361060 A1
(43) Pub. Date: Nov. 12, 2026

(54) Hardwired Electrical Device with Integrated Beacon and Optional External Antenna

(71) Applicant: Michael Evan Lambert, Wilmington, NC (US)

(72) Inventor: Michael Evan Lambert, Wilmington, NC (US)

(21) Appl. No.: 19/540,772

(22) Filed: Feb. 15, 2026

Related U.S. Application Data
(63) Continuation of application No. 19/204,502, filed on May 10, 2025.

(51) Int. Cl. H02G 3/08; H01Q 1/24; H01Q 1/32

(52) U.S. Cl. CPC H02G 3/081; H01Q 1/242; H01Q 1/243; H01Q 1/3275

(57) ABSTRACT

The invention is a permanently installed electrical device, such as a wall receptacle, switch, smoke detector, or other in-wall fixture, with an integrated wireless module capable of transmitting localization or environmental awareness signals. The device draws power from standard building line voltage and supplies regulated low-voltage power to the wireless module through an internal power conversion system. An external antenna may be routed through or mounted to a faceplate.

### BACKGROUND

Many current indoor localization systems rely on battery-powered or plug-in beacon devices. These solutions can be unreliable, movable, maintenance-intensive, and often incompatible with building codes or professional-grade installations. Additionally, such systems typically require proprietary hubs or cloud integration. A need exists for a tamper-resistant, line-powered, infrastructure-anchored localization device that integrates seamlessly into standardized electrical infrastructure and building systems.

### SUMMARY

The present invention provides a hardwired electrical device, such as a standard wall receptacle, switch, smoke detector, or in-wall module, comprising an integrated wireless signal-emitting module. The wireless module is configured to transmit signals usable for localization, environmental context, or automation. In various embodiments, the device is powered directly from building line voltage and includes an internal power conversion circuit that outputs a low-voltage supply suitable for the wireless module.

In contrast to mobile, plug-in, or battery-powered beacons, the present invention is permanently installed into electrical infrastructure, thereby offering a fixed spatial reference for localization systems.

The wireless module may support various localization technologies, including but not limited to Bluetooth® Low Energy (BLE), Ultra-Wideband (UWB), infrared (IR), time-of-flight (ToF), radio-frequency (RF), acoustic ranging, or other spatial signal protocols. The device may include an internal antenna or provide support for an external antenna mounted to a faceplate or cover.

The invention is a hardwired electrical device comprising: a housing configured for mounting in a standard electrical junction box; a power conversion module configured to convert AC mains voltage to a regulated DC voltage; and a wireless module powered by the power conversion module and configured to transmit signals usable for spatial localization or environmental awareness. The device additionally performs the full primary function of a receptacle, switch, smoke detector, or other electrical fixture.

The wireless module can support one or more of: Bluetooth® Low Energy, Ultra-Wideband, infrared, time-of-flight, acoustic ranging, or other localization-capable technologies.

The device can include an antenna electrically connected to the wireless module, wherein the antenna is embedded within the housing or externally mounted on a portion of the device.

The external antenna can be mounted to a faceplate or cover and is electrically connected via an internal wire.

The external antenna can comprise a modular unit attachable to the faceplate via snap-fit, magnetic, or twist-lock connection.

The wireless module can be configured to operate in a mode selected from the group consisting of: continuous transmission, toggled transmission, or suppressed transmission triggered by external signal.

The wireless module can broadcast a digital identifier associated with a room, zone, or coordinate reference.

The device can be compatible with third-party localization or automation platforms and operates independently of a proprietary hub.

The housing can be selected from the group consisting of: wall receptacle, switch, motion sensor, smoke detector, or in-wall automation module.

The invention includes a system comprising a plurality of disclosed devices, wherein each device broadcasts a signal representing its fixed location to assist a mobile receiver with determining spatial position.

The device can comprise one or more environmental sensors, wherein the sensors are configured to transmit data associated with environmental conditions in conjunction with, or independent of, the wireless localization module.

The housing can be configured for compliance with the National Electrical Code (NEC) or equivalent safety standards.

The wireless module can be powered directly by the power conversion module or indirectly through one or more intermediate electrical components, including but not limited to energy storage devices, voltage regulators, power-conditioning circuits, capacitors, microcontrollers, switching elements, or other components configured to buffer, control, or temporarily store power.

The device can comprise a firmware system configured for over-the-air (OTA) updates.

The firmware may be configured for always-on transmission, toggle-controlled modes, privacy-enhanced operation, or programmable intervals. One of ordinary skill in the art will recognize that these modes may be statically configured, triggered remotely, or updated via over-the-air firmware modifications. The terms “may,” “can,” and “configured to” are intended to describe optional functionality and implementations. While specific embodiments are described herein, the invention is not limited to those implementations.

### BRIEF DESCRIPTION OF THE DRAWINGS

FIG. 1 is a side view of an electrical device (100) made for mounting in a junction box, with a housing (101) that contains a switching and beacon module. A small barrier (102) separates high voltage from low voltage components. Wires (103) exit the housing to connect to the circuit. An antenna wire (104) and ventilation features (105) are also shown.

FIG. 2 is a top view of the housing (101) showing mounting columns (106) for the switching module and separate mounting columns (107) for the beacon module.

FIG. 3 is a cutaway side view showing internal connections between components. A switching module (108) supplies power through low voltage wires (110) to a beacon module (109). Mounting columns (106, 107), barrier (102), antenna wire (104), and external wires (103) are visible within the housing (101).

FIG. 4 is a front view of a receptacle beacon device (201) that includes a faceplate (111), antenna (112), and a standard receptacle (113).

FIG. 5 is a front view of a switch beacon device (202), showing faceplate (111), antenna (112), and switch (114).

FIG. 6 is a front view of a dead front or blank beacon device (203) showing faceplate (111), antenna (112), and a blank or configurable front surface (115) for mounting.

FIG. 7 is a side view of a smoke, carbon monoxide, or environmental detector beacon device (204). It includes the detector body (116), a mounted housing (101) containing the modules, antenna wire (104), ventilation (105), antenna (112), and wires (103).

FIG. 8 is a schematic floor plan showing distributed devices across an interior space. Devices marked “X” represent beacon-enabled receptacles, switches, or dead fronts (201, 202, 203). Devices marked “(O)” represent smoke, carbon monoxide, or environmental beacon devices (204). Devices marked “(\hat{ })” represent client or user devices (205), such as robots, smartphones, or other smart systems that interact with anchors for localization or distance estimation.

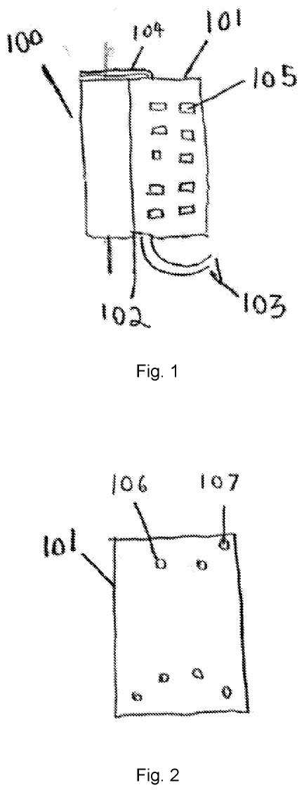

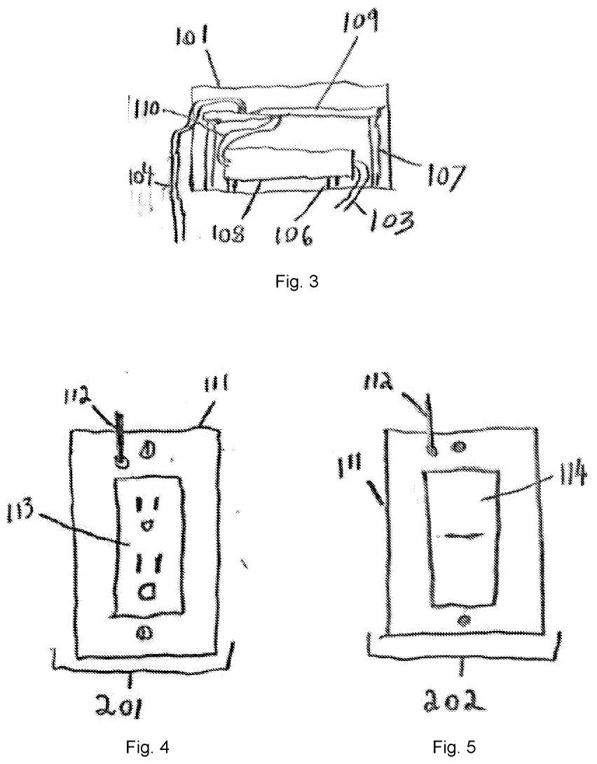

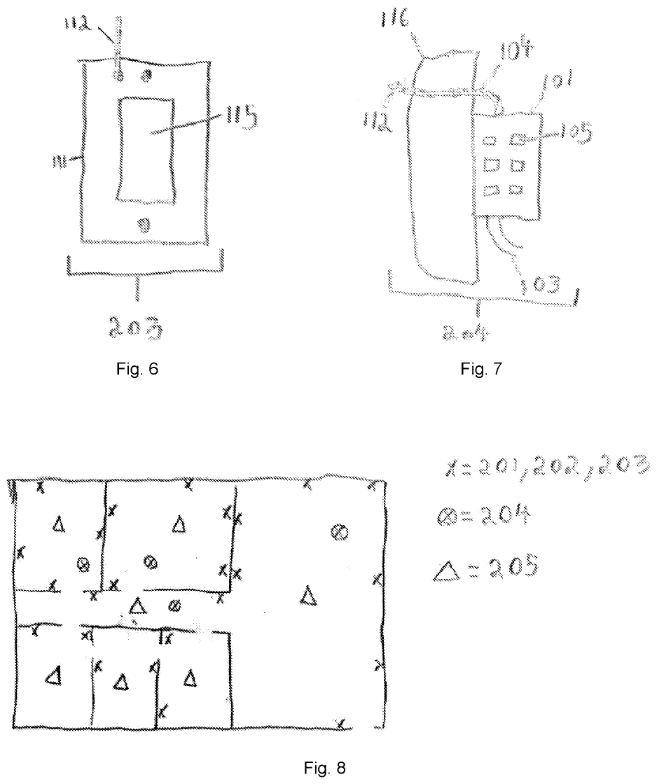

### DETAILED DESCRIPTION

### 1. Housing and Installation

In various embodiments, the device includes a housing conforming to common electrical form factors (e.g., Decora, toggle, duplex, or modular shapes). The device is intended for installation into standard junction boxes and may be affixed using conventional electrical fasteners. One embodiment mounts directly behind a receptacle or switch and connects in parallel to the existing branch circuit. The housing may be constructed from heat-resistant polymer and feature venting slots to reduce thermal buildup.

In all embodiments, the electrical device retains its core electrical or sensing function, such as power delivery (for receptacles and switches) or hazard detection (for smoke and CO detectors), and the beacon capability is added without impairing or replacing the device's original purpose.

The device is intended for use in residential or commercial installations and may be configured for compliance with relevant safety, performance, or radiofrequency standards, including but not limited to NEC, UL, or CE requirements.

### 2. Power Conversion Module

The device includes an AC-to-DC conversion module configured to step down 120 V or 240 V AC to a stable low-voltage output (e.g., 3.3 V or 5 V). The conversion module may include onboard isolation, filtering, or overcurrent protection. In the prototype embodiment, input wiring enters via 14 AWG conductors, steps down via a switching power module, and supplies output via 20 AWG soldered leads. The power section may be electrically isolated from low-voltage logic components.

### 3. Beacon Module Integration

The device includes a wireless module (beacon) configured to transmit signals used in localization or environmental sensing. The beacon is powered by the low-voltage output of the internal conversion module. In one embodiment, the beacon module is physically separated from the power conversion circuitry by a plastic or insulated barrier and may be mounted using dedicated supports within the housing. The beacon may be a commercially available development board or integrated circuit and is electrically connected to the antenna and firmware systems described in Sections 4 and 5.

### 4. Antenna Configuration

The antenna may be:
Embedded directly in the housing (e.g., PCB trace, chip-style)
Routed externally to a faceplate or cover via internal wiring
Attached using SMA, U. FL, coaxial connectors, or flex cable extensions
Supported by a molded, slotted, or magnetically retained fixture within the faceplate

In some embodiments, the RF signal line (e.g., RL pin) may be redirected internally to accommodate external antenna mounting. The antenna may be modular, interchangeable, or upgradeable.

### 5. Firmware Behavior

In various embodiments, the firmware is configured to support:
Continuous beaconing
Toggle-controlled beaconing (e.g., via mesh packet or app)
Privacy modes where transmissions are suppressed unless triggered
Configurable transmission intervals, channels, or signal strength
Firmware updates over-the-air (OTA)

### 6. Optional Environmental Sensing

In certain embodiments, the device may include one or more environmental sensors, wherein the sensors are configured to transmit data related to temperature, humidity, air quality, light, occupancy, or sound levels in conjunction with, or independent of, beacon signals.

### 7. System Integration and Use Cases

Devices may operate individually or as part of a system of spatial anchors. Each device may broadcast a room ID, zone label, or coordinate reference. The system may operate without a proprietary hub and integrate into existing wireless infrastructure. The invention enables applications in smart homes, robotics, augmented reality systems, secure access zones, retail analytics, building automation, or robotic navigation.

### 8. Prototype Implementation Example

One embodiment of the invention includes a commercially available development board (e.g., Nordic or Decawave) mounted to the rear of a standard Decora-style receptacle. The board is powered by a compact AC-to-DC switching module and broadcasts BLE or UWB packets for spatial positioning. The antenna may be routed to the faceplate using a short coaxial line.

While the preferred embodiment has been described, alternate implementations may incorporate equivalent functionality. This includes the use of alternative power modules, communication protocols, antenna placements, enclosure types, or additional sensors. Claims are intended to cover any modification or variation that accomplishes substantially the same function as described, regardless of specific form, material, or application context. No limitation to the specific configuration shown in the prototype drawings is intended unless explicitly stated in the claims.

What is claimed is:

1. A dedicated electrical anchor device configured for mounting to a standard electrical junction box, comprising:
a housing containing a power-conversion module configured to convert alternating-current (AC) mains voltage to a regulated direct-current (DC) voltage;
a wireless-localization module powered by the power-conversion module and configured to transmit signals usable for ranging or localization; and
an antenna electrically connected to the wireless-localization module, wherein the device is configured to operate as a fixed spatial anchor independent of a receptacle, switch, or other primary electrical function.

2. The device of claim 1, wherein the wireless-localization module supports Ultra-Wideband (UWB) and Bluetooth Low Energy (BLE) technologies, each selectively usable for communication, ranging, or localization depending on firmware configuration.

3. The device of claim 1, wherein the antenna is positioned within a radio-frequency-transparent window or region on a face or cover of the housing formed of polymer, glass, or composite material to reduce attenuation of wireless signals.

4. The device of claim 1, further comprising one or more programmable-input elements configurable through firmware to perform variable or user-defined functions based on system configuration.

5. The device of claim 1, wherein the wireless-localization module further supports Zigbee, Thread, or Matter mesh-communication protocols for device-to-device networking or timing synchronization.

6. The device of claim 1, further comprising one or more sensors configured to detect environmental parameters including temperature, motion, light level, or vibration for use in localization accuracy or system diagnostics.

7. The device of claim 1, further comprising a data-interface port selected from a USB-C, UART, or similar connector configured for wired communication, debugging, or firmware update.

8. The device of claim 1, wherein the power-conversion module includes over-voltage, surge, or thermal protection configured for continuous building-mains operation.

9. The device of claim 1, wherein the housing comprises metallic or coated regions providing electromagnetic shielding except at the radio-frequency-transparent window.

10. The device of claim 1, wherein the housing includes a removable cover permitting service access to the internal circuit board without detaching the device from the junction box.

11. The device of claim 1, wherein the circuit board is modular and removable to permit replacement or upgrade of the wireless-localization module.

12. The device of claim 1, wherein the antenna is detachable or repositionable through a coaxial, flex-cable, or board-to-board connector.

13. The device of claim 1, further comprising an external-antenna port disposed on the housing and electrically coupled to the wireless-localization module, the antenna port being configured to receive a detachable external antenna through a coaxial or threaded connector.

14. The device of claim 1, wherein the wireless-localization module includes over-the-air update capability and remote configuration through BLE communication.

15. The device of claim 1, wherein the housing and internal circuitry are configured for compliance with electrical-safety and radio-frequency-emission standards applicable to permanently installed junction-box equipment.

16. A lighting fixture comprising:
a housing containing one or more light sources;
a power circuit configured to receive AC mains voltage and distribute regulated power to the light sources and to a wireless-localization module; and
an antenna coupled to the wireless-localization module and positioned within or adjacent to a non-metallic region of the housing to facilitate signal transmission.

17. The lighting fixture of claim 16, wherein the wireless-localization module supports Ultra-Wideband (UWB) and Bluetooth Low Energy (BLE) technologies, each selectively usable for communication, ranging, or localization depending on firmware configuration.

18. The lighting fixture of claim 16, wherein the wireless-localization module includes firmware-configurable input elements operable for diagnostics, synchronization, or other software-defined functions.

19. The lighting fixture of claim 16, wherein the wireless-localization module supports Zigbee, Thread, or Matter mesh communication.

20. The lighting fixture of claim 16, wherein the housing and internal circuitry are configured for compliance with electrical-safety and radio-frequency-emission standards applicable to permanently installed luminaires.
